(19) United States
(12) Patent Application Publication
(10) Pub. No.: US 2011/0137975 A1
(43) Pub. Date: Jun. 9, 2011

(54) SECURE PROFILING METHOD PROVIDING PRIVACY IN SOCIAL NETWORKING SYSTEMS

(75) Inventors: Dipankar Das, Foster City, CA (US); Len L. Mizrah, San Carlos, CA (US)

(73) Assignee: Authernative, Inc., Redwood City, CA (US)

(21) Appl. No.: 12/631,671

(22) Filed: Dec. 4, 2009

(51) Int. Cl. G06Q 30/00; G06F 3/01; G06F 15/16; G06Q 10/00

(52) U.S. Cl. 709/203; 715/753; 705/14.66; 709/204

(57) ABSTRACT

The present invention includes devices and methods for enabling private and secure data collection by profile servers relating to users that are associated with a profiling user in a social networking system. Particular aspects of the present invention are described in the claims, specification and drawings.

### BACKGROUND OF INVENTION

1. Field of Invention

The present invention relates to secure profiling technology that allows providing privacy in social networking systems and other networks in which profiling users are associated with other users via the network.

2. Description of Related Art

Privacy has become a prime concern for online users in social networking systems such as Facebook, MySpace, etc. Users are extremely wary of their personal profile information being automatically shared by the social networking systems with others simply by virtue of enrollment. On the other hand, online advertisers need to know users' behavioral information in order to correctly target their advertisements to Internet users to be cost efficient and effective. Behavioral tracking of Internet users by targeted advertising companies, which is enabled by Web technologies, raises serious public and legal concerns (see, for instance, http://www.out-law.com/page-10410 and http://en.wikipedia.org/wiki/Behavioral_targeting#cite_note-7). In the present social networking environment, there is no way to balance concurrently these two goals of preserving users' privacy and providing for accurate targeted advertising.

Online targeted advertisement requires a prior knowledge of consumers' profiling data. Consumer profiling is performed using various methods like capturing click stream data using a cookie, looking into a consumer's profile from a subscription database, mining consumer survey data, etc.

Prior art has been unsuccessful in balancing the privacy concerns of the Internet users with their behavioral tracking by online advertisers. A number of patents disclosed technologies that require Personally Identifiable Information (PII) to create a targeted consumer record id. U.S. Pat. No. 7,257,589 mentions targeting ads based on content of the document accessed by the user. U.S. Pat. No. 7,203,684 describes how content of an email document can be read by a system to display ads relevant to the content. Also, U.S. Pat. No. 7,062,510 describes how a consumer's purchase history records can be analyzed to produce targeted ads. U.S. Pat. No. 5,774,170 discloses a system for delivering targeted advertisement to the consumer by using a commercial identifier (CID). In this system, a set of advertisements is tagged with the CID.

These processes collect an enormous amount of data about consumers' online activities, raising concerns among the privacy advocates. According to survey results mentioned in a congressional committee on privacy “Profiling Report (part 1), June 2000”, most users do not like that their online activities are tracked. The U.S. Congress has analyzed the privacy concerns and suggested that the business community should self regulate these matters. Also, it has proposed that business community take adequate safeguards to protect consumer data.

Another major problem with the present advertising system is that fully automated targeted advertising systems are not efficient. It is difficult to judge purchasing behavior of a consumer by applying computing algorithms alone over some data collected from the consumer's online activities. It produces a lot of false positives.

Another common practice is to exchange profile data from various subscription organizations and to build a massive database. Such a database becomes a lucrative target for an adversary. Although various measures are taken to secure the database, information centralized over one or few systems is very likely to be breached by an internal or external adversary. As long as PII and profile are sitting together in one place, there are good chances of data theft and misuse of data.

There are alternative ways to target advertisements without profiling individual consumers. In the US Patent Application, “SYSTEM FOR ELECTRONIC COMMERCE”, U.S. Patent Application Publication No. 2009/0037257, a targeted advertising system based on a community influencer has been described. In this system, a social web community member creates an account in a web server. This member becomes one of the influencers in the community and creates tags to target ads in his/her own web pages or in the community web pages. U.S. Patent Application Publication No. 20050234781 describes as to how to provide e-commerce retailers with self-selected targeted marketing and referral-selling to affinity groups by allowing individuals or groups to interactively select associated products and services. However, none of these methods are efficient in targeting individual consumers.

For the foregoing reasons, there is a substantial need for a consumer profiling system that does not provide online advertizing companies direct technological capabilities to track individual Internet users' behavior, while being more efficient in targeting advertisements and yet does not compromise online consumers' privacy and security. In a social networking system, a user maintains a list of other users as the associated users. Users of the social networking system interact with other users and share their thoughts, ideas and experiences. In many cases, a user has a connection with an associated user in real life. With such knowledge of the associated users, a user can profile them for their tastes and habits, and other parameters. This provides a serious opportunity for the advertisers to collect profile information about the users of the social networking system by offering to the users certain online compensation programs. However, this profiling has to be very secure so that it does not reveal the PII of the profiling user and the associated users to the advertisers and to other adversaries. Any user of a social networking system can be a profiling user and an associated user for other one or more profiling users concurrently. Also, it is worth to mention, that profiling of users in social networking systems, while maintaining users' privacy and data security, is applicable not only for targeted advertising, but also for a number of other commercial and social areas like professional orientation, job search, polling, health, educational, travel, and insurance services, etc.

### SUMMARY OF THE INVENTION

With the increasing popularity of social networking systems, it is possible to use human intelligence to profile a large number of consumers who are also members of social networking systems.

A profiling system described below is based on a capability to enable users of social networks (and other similar networks) to manage delivery of advertisements to the others with whom they are associated through the social network. A profiling interface is executed for the profiling user at a terminal coupled to the computer network. The profiling interface provides a set of profile attributes that can be used to select advertisements. The profiling interface enables linking of profile attributes to associated users in response to input received via the profiling interface. Once the associated users have been linked with profile attributes, profile records are created. The profile record includes the linked profile attributes and a hash value created by one-way encryption of the profiling user id, a profiling user secret code, the associated user id, and the social networking system's id. The profile records are stored in the profile server and used to identify virtual ad targets. An advertising system is able to select and deliver ads through the profile server to the virtual ad targets without access to PII of the profiling user and the associated users. The profiling user can access the profile server, and retrieve ads that have been delivered to the profile server for the profile records, and then forward the ads to the appropriate associated user.

### BRIEF DESCRIPTION OF THE DRAWINGS

FIG. 1 illustrates the interaction of various system components, such as the profiling interface program, a profile server, ad servers and a social networking system.

FIG. 2 shows possible types of user interfaces embedded into various social networking systems.

FIG. 3 is a flow chart depicting a method of an associated user profiling.

FIG. 4 is a flow chart depicting advertisements delivery.

FIG. 5A, FIG. 5B, and FIG. 5C show several possible approaches to build a veiling ID for an associated user by utilizing a one-way encryption technique and a combination of system id parameters and user credentials.

FIG. 6 is a block diagram of a computer system implementing a client interface for profiling associated users.

FIG. 7 illustrates an article of manufacture comprising a computer readable medium storing a profiling interface program.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

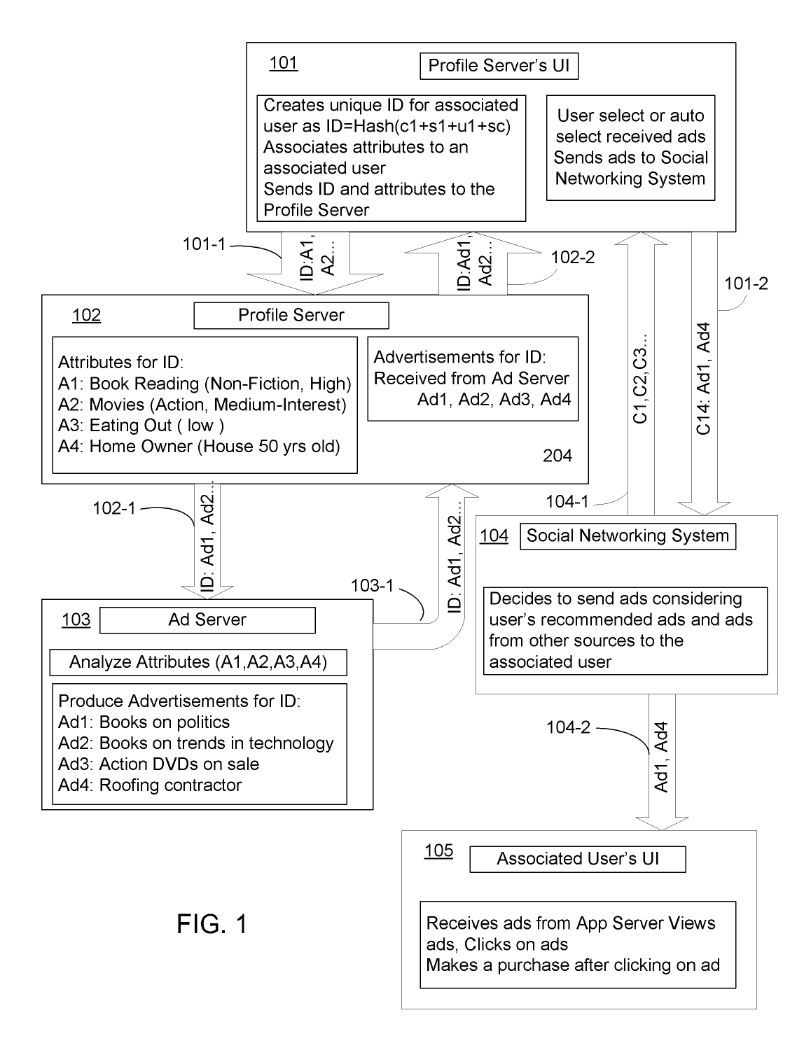

FIG. 1 illustrates the interaction of various system components such as profiling interface program with the profile server and the social networking system. The profile server includes profiling interface 101 which can be developed as an embedded application for the social networking system's client program. Profile server 102 can be a client-server application being executed at a platform coupled to the Internet associated with a specific social network or independent from a specific social network. The profile server has a list of attributes developed for a social networking system. Different sets of profile attributes may be used for different communities within the same social networking system. These attributes are chosen and published by the experts in the social networking system. Profile attributes can be about demographic and psychographic information. In a preferred embodiment system, the list of profile attributes is provided to the profiling users as a closed set, to which the profiling user cannot add new attributes. This prevents creation of attributes that could reveal PII of the associated users.

Profile server 102 has a database to store profile records and advertisements. Advertisements come from ad server 103 using data communications pipe 103-1. An advertisement can be a URL address pointing to an ad server or it can be text data, graphic image data, video data, or IPTV (Internet Protocol Television) stream data representing a complete advertisement. Profile server 102 provides profiling interface 101, which can be developed as an embedded application for the social networking system's client program or otherwise provided to the profiling user. Social networking system 104 includes any network application, pluggable application interface or device that allows its members to keep a list of other members as their associated users. Some examples of the social networking systems are Facebook, MySpace, instant messenger applications like Yahoo Messenger, MSN Messenger, email applications like Gmail, Yahoo email, Hotmail, mobile phones that have adopted customizable application development frameworks with ability to maintain an associated user list, and video game console or television set top boxes with ability to maintain an associated user list.

Social networking system server 104 and ad server 103 should be registered with profile server 102. During the registration an id is assigned to each server. This id can be the domain name of the system. When profile server's client 101 is launched inside the social networking system's client program, it receives the id of the social networking system.

Profile server's client 101 has ability to pull the associated user list consisting of associated users from the parent application, which is a client interface of social networking system 104. The associated user list is not sent to profile server 102.

Client 101 creates a one-way encrypted entry record for each associated user in the form of id-hashes for each associated user comprising the following parameters: the profiling user's secret code (chosen at will by the profiling user, and according to the online system policies), the profiling user's id in the social networking system, the associated user's id in the social networking system, and the id of the social networking system. One way encryption can be implemented using the SHA-1, SHA-2, or MD5 hash functions, or another strong cryptographic hash function which produces a cipher that is resistant enough against brute force attacks. Each entry is expressed as ID=Hash(c1+s1+u1+sc), where c1 is the associated user handler, i.e., the user id of the associated user in the social networking system; s1 is the social networking system id, i.e., the domain name or other registered id for the social networking system; u1 refers to the user id, i.e., the user id of the profiling user in the social networking system, and sc is the user's secret code which is never stored in any system. Indeed, system administrators and other network internal employees do not (and should not) have access to a user's secret code as it is never stored in any computer-networking system. Hence, they cannot retrieve the list of associated users and their respective IDs and attributes. On the other hand, the advertisers never see the associated users' PII, as well as the profiling user's PII, as the only information transferred to them is a list of veiling user IDs with associated attributes.

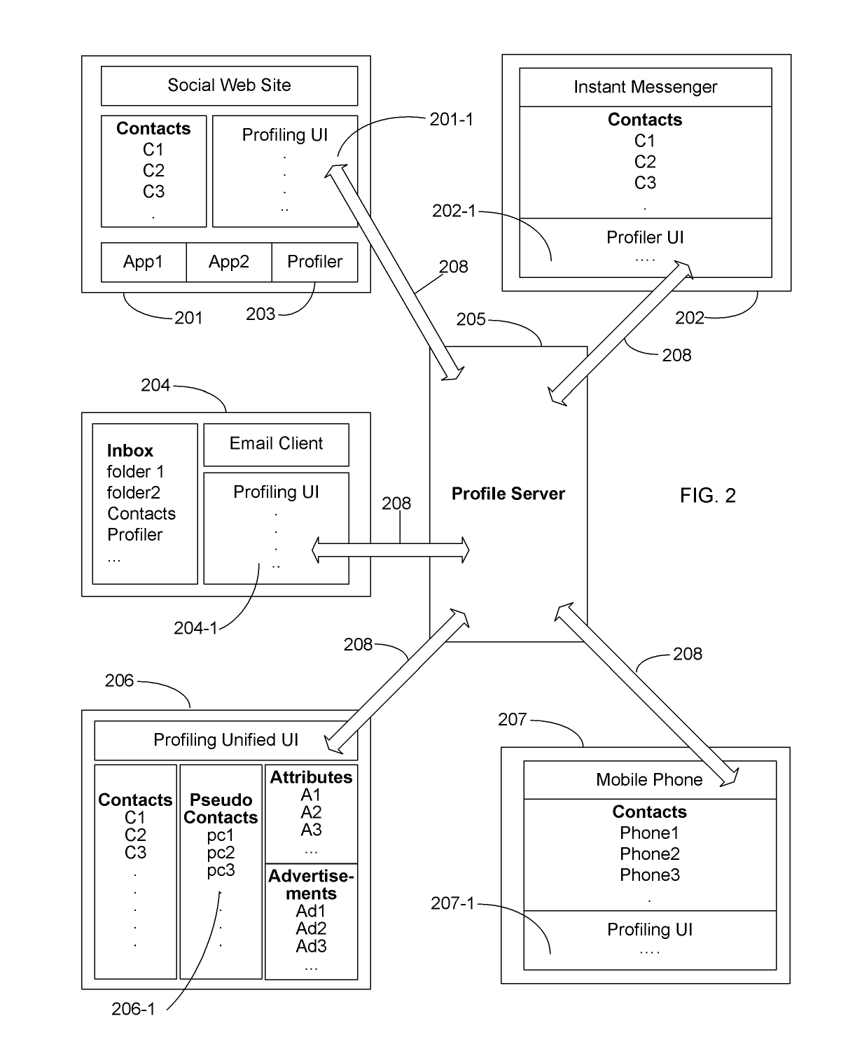

FIG. 2 illustrates possible types of a user interface embedded in various social networking systems. In this figure, associated users are referred as contacts. Client programs are connected to profile server 205 using communication pipe 208. The profile server is a J2EE web application server or similar client server application system that can function over computer networks.

The profile server's interface can be delivered to the profiling user's computer by delivering a computer program from a server in the computer network to the computer terminal, the computer program including instructions executable by a processor in the computer terminal in support of the profile server's interface. In one example, the profile server's interface is provided to the profiling user by publishing a web page using an executable markup language in support of said profile server's interface, the web page accessible in the computer network. The profiling user computer includes a browser through which the profiling user accesses the web page and launches an embedded program that provides the profile server's interface.

In social web site 201, for example Facebook, LinkedIn, MySpace or similar social web sites, the profile server's interface 201-1 can be launched as html IFRAME application. Interface 201-1 can be developed using the API and guidelines provided by the social web site.

Instant messenger application 202 like MSN Messenger, or Yahoo messenger, profile server's interface 202-1 can be developed as a plug-in application with the API and tools provided by the instant messenger provider.

In email client application 204, profile server's interface 204-1 is developed according to the API and guidelines provided by the email client provider. Email client 204 could be a web email application like Gmail, Hotmail or installed application like Outlook, Mozilla Thunderbird, or similar electronic mail systems. In this environment, the email address becomes the associated user's handle or id.

In mobile phone 207 where custom applications are allowed to communicate using the network to a remote server, client interface 207-1 can be developed to profile associated users stored in the phone. In this case, the associated user handle or id is the phone number.

In the preferred embodiment, profile server's unified client interface 206 is implemented in such a way that the profiling user gives some fictitious name (pc1, pc2, pc3, and etc. called pseudo associated user) to each associated user. These fictitious names are stored in a profiling user's own device. There are no provisions to store pc1, pc2, pc3 in the profile server. The unified client has ability to import associated users from various social networking systems that allow export of associated user list. User can associate any ads to selected associated users and send them to the corresponding social networking system.

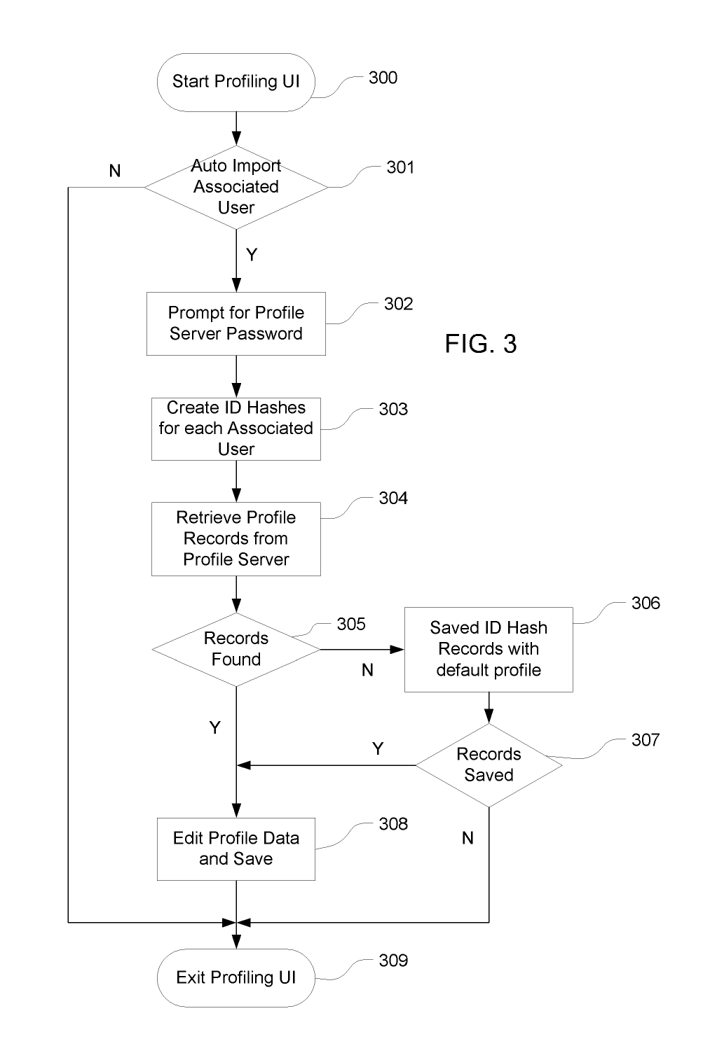

FIG. 3 is a flow chart depicting a method of associated user profiling. After delivery to a profiling user, the profile server's interface is launched (300) and associated users are automatically imported to the profile server's interface program (301). The profiling user is prompted for a secret code (302) which once entered initiates a process of creating a one way encrypted entry records or ID hashes for each associated user (303). After creating the ID hashes for each associated user, the profile records are retrieved from the profile server (304). If a particular profile record is found having a matching ID hash (305), then the profile data can be edited by the profiling user, such as by adding or deleting profile attributes, and then saved (308). If the profile record is not found, then the ID hash record is saved with a default profile and saved as a new record (306). If new records are created and saved (307), then the profile data can be edited by the profiling user linking the associated user to attributes from the predetermined set, such as by adding or deleting profile attributes, and then saved (308). If new records have not been created and saved at step (307), and all other profile records selected for set up or changes have been edited and saved at step (308), then the profile server's interface is exited (309). Thus, the profile server's interface program supports a process including loading a list of associated users for the profiling user; for each associated user in the list, determining whether a profile record is stored for the associated user, and if not, creating and storing a profile record; and if the profiling user links one or more profile attributes with the associated user, updating the profile record.

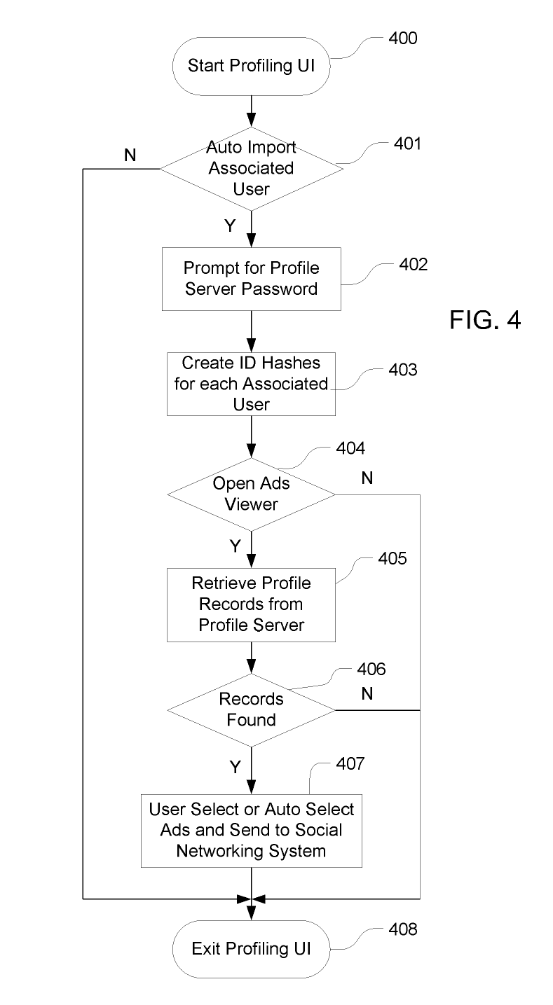

FIG. 4 shows a flow chart to illustrate the processing of information to send ads to the social networking system for the associated users. The user can be motivated by financial rewards or by elevating rankings in a social networking system. The social networking system may reward its users based on how many ads it receives from a profiling user. It also can reward the user based on quality and performance of the ads. Privacy of the associated users is protected since the social networking system keeps only the records of linking the profiling user with the ads. The associated user is not linked to the profiling user. All users who send a performing advertisement can be rewarded irrespective of whether or not associated users become customers. The process includes starting the profile server's interface (400). Then, the associated users are loaded into the interface program (401). The interface prompts the profiling user for his or her profile server secret code (402), and then the profile interface creates ID hashes for each associated user (403). Next, an ad viewer process is opened (404). The ad viewer process retrieves profile records for the profiling user from the profile server database (405). If records are found (406), then the profiling user selects ad associated with the ID hashes for delivery to the associated users of the network (408). This selection can be manual or automatic, preferably operating only after the profiling user is able to decode the ID hashes and determine which ads to pass to his or her associated users. After the profiling user selects ads for delivery, the ad viewer and profile server's interface program exits (409). In this process, only the profiling user is able to match the ads with associated users. By design, the profiling user can protect privacy and security of the associated users from exposure to internal and outside intruders. The profiling user's secret code is never stored in any system. If the profiling user forgets the secret code, he would need to re-create the list of associated users with another set of IDs based on a changed secret code.

The social networking system can receive advertisements from multiple friends of a single user. The social networking system gives a score to each advertisement based on seasonal relevance of the advertisement and ranking of the profiling user. Advertisements with higher scores are displayed to the user.

In order to maintain the privacy concerns of the user and the associated users, the profile attributes are provided as a closed set to the profiling user. The closed set of profile attributes can be selected by privacy experts, so that a profile does not contain personally identifiable information. For example, certain demographic information could be personally identifiable information in a smaller community. In such situation, privacy experts should remove such demographic information from the list of profile attributes. It is beneficial to remember that security and privacy cannot be achieved by this system alone. All the parties involved in this interaction should abide by the privacy rules. That would most likely involve relevant enacted laws and it will require some new technologies to detect and filter out forbidden activities. Ad server should not send ads that can produce feedback to identify a consumer with the profile. Also future enhancements in the browser technology for data protection could prevent advertisers from collecting user data to enhance users' privacy.

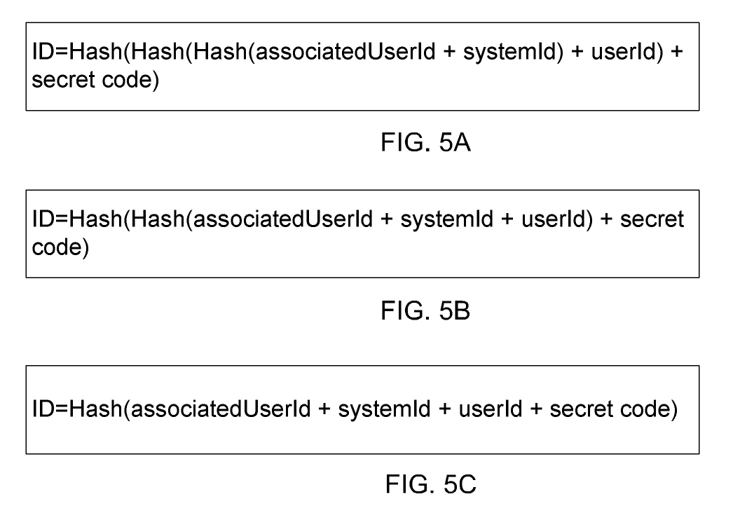

FIG. 5A-5C show several possible approaches to build a veiling ID for an associated user by utilizing a one-way encryption technique and a combination of system id parameters and user credentials. They are all used to enhance security of the ID hash. The profile server searches for the ID-hashes. If an ID-hash is not found in the database, a new record is created with a default profile. A default profile can be a set of attributes selected for a social networking system as default attributes. Profile server sends the profile record to client interface 101. The profiling user can edit the profiles for each associated user and save the changes using communication pipe 101-1. Only the profile attributes and the ID-hashes are sent using the communication pipe 101-1. No identifiable information about the profiling user or the associated user is sent to the profile server.

Profile server 102 periodically sends the profile records to the ad server 103 with a request for updated ads. Ad server 103 analyzes the received attributes and finds relevant ads from its database. Ad server 103 responds with relevant ads to profile server 102 using communication pipe 103-1. In one embodiment, the ID sent through 102-1 and 103-1 is different from the ID sent through 101-1. A new ID is generated for each ID-hash and stored in a database table. This can further strengthen security against a sophisticated brute force processing attack that could be performed by an intruder at the ad server.

Client interface 101 has a screen for displaying the ads received for a profile. The profiling user can send a refresh command to display the latest ads received for a profile or a list of profiles. Profiling user may see a list of ads for each profile. The profiling user sends the ads to social networking system 104 after selecting some ads. Ads are sent coupled with the associated user handle so that the social networking system can show the ads to the associated user's profile.

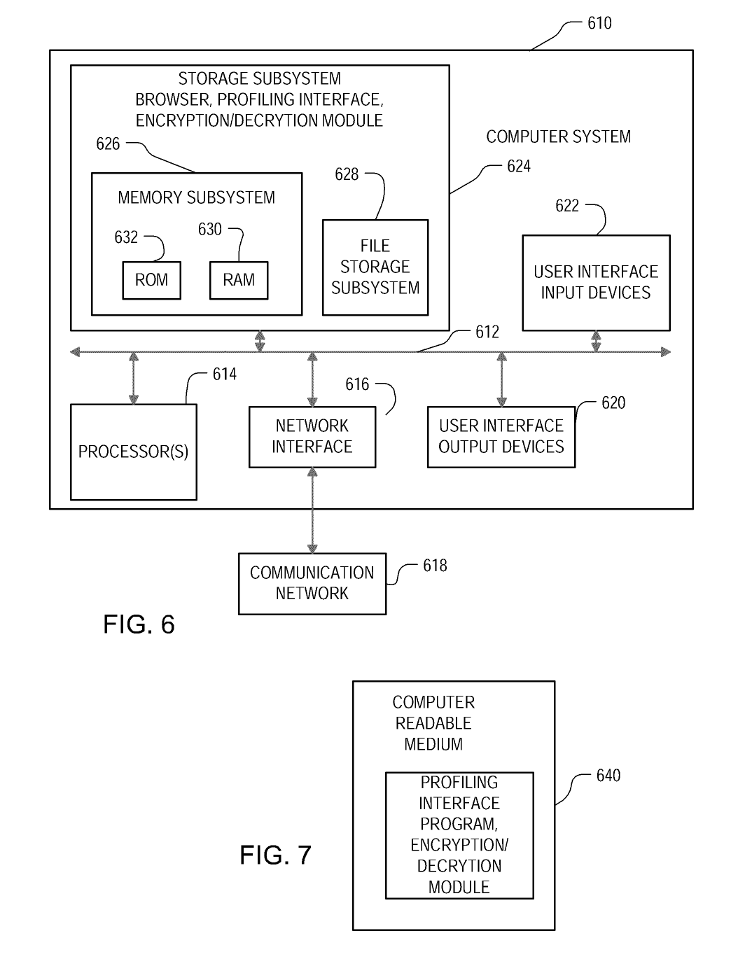

FIG. 6 is a simplified block diagram of a computer system 610 suitable for use with embodiments of profiling a user and user's associated user profiles. Client computer system 610 typically includes at least one processor 614 which communicates with a number of peripheral devices via bus subsystem 612. These peripheral devices may include a storage subsystem 624, comprising a memory subsystem 626 and a file storage subsystem 628, user interface input devices 622, user interface output devices 620, and a network interface subsystem 616. The input and output devices allow user interaction with computer system 610. Network interface subsystem 616 provides an interface to outside networks, including an interface to communication network 618, and is coupled via communication network 618 to corresponding interface devices in other computer systems. Communication network 618 may comprise many interconnected computer systems and communication links. These communication links may be wire line links, optical links, wireless links, or any other mechanisms for communication of information. While in one embodiment, communication network 618 is the Internet, in other embodiments, communication network 618 may be any suitable computer network.

User interface input devices 622 may include a keyboard, pointing devices such as a mouse, trackball, touchpad, or graphics tablet, a scanner, a touch-screen incorporated into the display, audio input devices such as voice recognition systems, microphones, and other types of input devices. In general, use of the term “input device” is intended to include all possible types of devices and ways to input information into computer system 610 or onto computer network 618.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image, a video signal or an IPTV stream. The display subsystem may also provide non-visual display such as via audio output devices. In general, use of the term “output device” is intended to include all possible types of devices and ways to output information from computer system 610 to the user or to another machine or computer system.

Storage subsystem 624 stores the basic programming and data constructs that provide the functionality of some or all of the processes described herein, including the client program and executable instructions. The executable instructions are the logical instructions which enable a user interface to match profile attributes with the selected associated users. The executable instructions further include logic to store profile records and other applications which are to be performed on the profile records. These software modules are generally executed by processor 614.

Memory subsystem 626 typically includes a number of memories including a main random access memory (RAM) 630 for storage of instructions and data during program execution and a read only memory (ROM) 632 in which fixed instructions are stored. File storage subsystem 628 provides persistent storage for program and data files, and may include a hard disk drive, a floppy disk drive along with associated removable media, a CD-ROM drive, an optical drive, or removable media cartridges. The databases and modules implementing the functionality of certain embodiments may be stored by file storage subsystem 628.

Bus subsystem 612 provides a mechanism for letting the various components and subsystems of computer system 610 communicate with each other as intended. Although bus subsystem 612 is shown schematically as a single bus, alternative embodiments of the bus subsystem may use multiple busses.

FIG. 7 shows a computer readable medium 640, which can be a medium associated with file storage subsystem 628, and/or with network interface subsystem 616. The computer readable medium can be a hard disk, a floppy disk, a CD-ROM, an optical medium, non-volatile or volatile integrated circuit memory such as flash memory or DRAM, or removable media cartridge. The computer readable medium 640 can be part of a computer system executing a server for a social network or a profile server, and used for delivery of the profiling user profile server's interface program with an encryption and decryption module for the profile records to the profiling user, via a network. Also, it can be a removable or portable medium delivered to the profiling user by mail.

Client computer system 610 itself can be of varying types including a personal computer, a portable computer, a workstation, a computer terminal, a network computer, a smart phone, a television, a mainframe, or any other data processing system or user device. Due to the ever-changing nature of computers and networks, the description of computer system 610 depicted in FIG. 6 is intended only as a specific example for purposes of illustrating the preferred embodiments. Many other configurations of computer system 610 are possible having more or less components than the computer system depicted in FIG. 6.

While the above description contains many specifics, these specifics should not be construed as limitations on the scope of the invention, but merely as exemplifications of the disclosed embodiments. Those skilled in the art will envision many other possible variations that are within the scope of the invention.

What is claimed is:

1. A method for providing profiles of users in a computer network in which a profiling user is associated with a group of associated users, comprising
executing an interface for the profiling user at a terminal coupled to the computer network, the interface providing a set of profile attributes and enabling linking of profile attributes from the set with selected associated users in the group of associated users, the profile attributes capable of use in the selection of advertisements; and
linking profile attributes from the set to associated users in response to input received via the interface;
storing profile records for the selected associated users, the profile record for a particular selected associated user including profile attributes linked to the associated user by the profiling user and a one-way encryption technique applied to a combination of parameters, including a profiling user identifier, a secret code of the profiling user, and an associated user identifier.

2. The method of claim 1, including recording events related to delivery of advertisements to the associated users based on the profile records for the profiling user.

3. The method of claim 2, including assigning score to said events related to the delivery of advertisements.

4. The method of claim 1, including delivering a computer program from a server in the computer network to the computer terminal, the computer program including instructions executable by a processor in the computer terminal in support of the interface.

5. The method of claim 1, including publishing a web page using an executable markup language in support of said interface, the web page accessible in the computer network.

6. The method of claim 1, including
loading a list of associated users from the profiling user;
for each associated user in the list, determining whether a profile record is stored for the associated user, and if not, creating and storing a profile record; and
if the profiling user links one or more profile attributes with the associated user, updating the profile record.

7. The method of claim 1, including storing the profile records in a server accessible by the profiling user in the computer network.

8. The method of claim 1, including selecting advertisements for the associated user using the profile record by executing an interface for the profiling user, and delivering the selected advertisements to the associated user via the computer network.

9. The method of claim 1, wherein a server for a social network is coupled to the computer network, and said profiling user and said associated users are associated by links in the social network.

10. The method of claim 9, and including
loading a list of associated users for the profiling user from the server for the social network;
for each associated user in the list, determining whether a profile record is stored for the associated user, and if not, creating and storing a profile record;
if the profiling user links one or more profile attributes with the associated user, updating the profile record.

11. A system for providing profiles of users in a computer network in which a profiling user is associated with a group of associated users, comprising,
a processor,
a storage system coupled with the processor storing a plurality of executable instructions,
the executable instructions including
logic to present a user interface by which profile attributes chosen from a set of profile attributes are linked with selected associated users, and
logic to store profile records for the selected associated users, the profile record for a particular selected associated user including profile attributes linked to the associated user by the profiling user and a one-way encryption technique applied to a combination of parameters including a profiling user identifier, a profiling user security factor, and an associated user identifier.

12. The system of claim 11, wherein the executable instructions further include one way encryption logic protecting the associated user information.

13. The system of claim 11, wherein the executable instructions are delivered to the interface using a data communications pipe.

14. The system of claim 11, wherein the logic to store the profile records includes logic to send the profile records to a profile server.

15. The system of claim 11, the executable instructions including logic
to load a list of associated users from the profiling user;
for each associated user in the list, to determine whether a profile record is stored for the associated user, and if not, to create and store a profile record; and
if the profiling user links one or more profile attributes with the associated user, to update the profile record.

16. The system of claim 11, the executable instructions including logic to select advertisements for the associated user using the profile record by executing an interface for the profiling user, and to deliver the selected advertisements to the associated user via the computer network.

17. The system of claim 11, wherein a server for a social network is coupled to the computer network, and the profiling user and the group of associated users are associated by links in the social network.

18. The system of claim 17, the executable instructions including logic
to load a list of associated users for the profiling user from the server for the social network;
for each associated user in the list, to determine whether a profile record is stored for the associated user, and if not, to create and store a profile record;
if the profiling user links one or more profile attributes with the associated user, to update the profile record.

19. An article of manufacture, comprising,
a machine readable medium;
the computer program including executable instructions that comprise
logic to present a user interface by which profile attributes chosen from a set of profile attributes are linked with selected associated users, and
logic to store profile records for the selected associated users, the profile record for a particular selected associated user including a list of profile attributes linked to the associated user by the profiling user, and a one-way encryption technique applied to a combination of parameters including a profiling user identifier, a profiling user security factor, and an associated user identifier.

20. The article of claim 19, the executable instructions including logic
to load a list of associated users from the profiling user;
for each associated user in the list, to determine whether a profile record is stored for the associated user, and if not, to create and store a profile record; and
if the profiling user links one or more profile attributes with the associated user, to update the profile record.
